(19) United States
(12) Patent Application Publication
(10) Pub. No.: US 2025/0153598 A1
(43) Pub. Date: May 15, 2025

(54) CHARGING STATION MANAGING SYSTEM AND METHOD THEREOF

(71) Applicant: LITE-ON SINGAPORE PTE. LTD., Singapore (SG)

(72) Inventors: En Cheng Benjin Lau, Singapore (SG); Jen Ruey Ng, Singapore (SG); Ken-Weng Kow, Singapore (SG); Siong-Hin Gan, Singapore (SG); Shi-Ying Li, Singapore (SG); Jing Yang, Singapore (SG)

(21) Appl. No.: 18/765,384

(22) Filed: Jul. 8, 2024

(30) Foreign Application Priority Data
Nov. 9, 2023 (SG) 10202303192S
May 13, 2024 (CN) 202410587544.6

(51) Int. Cl. B60L 53/66; B60L 53/30; B60L 53/65; B60L 53/67; B60L 53/68; G06Q 50/06

(52) U.S. Cl. CPC B60L 53/665; B60L 53/305; B60L 53/65; B60L 53/67; B60L 53/68; G06Q 50/06; G06Q 2240/00

(57) ABSTRACT

A charging station managing system, includes the following elements. A tariff module, is used to set a tariff table of each charging connector based on at least one attribute, determine whether one of the charging connector is reserved, and determine whether the reserved charging connector is in a reservation expiration state. A staring module and a stopping module, are used to remotely control each charging connector to start charging/stop charging, and detect and record a starting time/a stopping time of a charging period and a reservation period of each charging connector. A payment module, is used to selectively calculate a charging fee, a reservation fee and a reservation expiration fee of each charging connector according to each tariff table, the charging period, the reservation period, and at least one attribute of each charging connector.

This application claims the benefits of the Singapore provisional application Serial No. 10202303192S filed Nov. 9, 2023, and the PRC application No. 202410587544.6 filed May 13, 2024, the disclosures of which are incorporated by reference herein in their entirety.

### TECHNICAL FIELD

The present disclosure relates to a charging managing mechanism, and in particular relates to a charging station managing system and method for managing tariff tables of charging connectors.

### BACKGROUND

As the rapid development of emerging energy sources, electric energy has been widely used in daily life. Electric energy may be applied in various types of electric vehicles, such as electric motorcycles, electric cars and electric buses. Charging stations have been widely set up by the government or private sector to provide the electrical energy required for electric vehicles. The charging station has multiple electric vehicle supply equipment (EVSE), and each EVSE has multiple charging connectors.

In order to more flexibly adapt to the needs of different users (for example, drivers of electric vehicles), the charging connector of the charging station may have a reservation function. Users may reserve the charging connector for a specific period and use the charging connector to charge during the reservation period. However, each of the charging connectors has different attributes, and each of the charging connectors has a different reservation period or charging period. In addition, the charging connector reserved by the user may have an expired reservation state.

In view of the above issues, it is necessary to provide an effective charging managing mechanism and expected to formulate a suitable tariff table according to the attributes of the charging connectors. Moreover, the fee of the charging connector may be accurately calculated based on the reservation period, charging period and reservation expiration state of the charging connector.

### SUMMARY

According to one embodiment of the present disclosure, a charging station managing system is provided. The charging station managing system is disposed in a cloud server and used to manage a plurality of charging connectors of a charging station. The charging station managing system comprises the following elements. A tariff module, for setting a tariff table of each of the charging connectors, determining whether one of the charging connectors is reserved, and determining whether the charging connector, which is reserved, is in a reservation expiration state. A starting module, for remotely controlling each of the charging connectors to start charging, receiving a first data of each of the charging connectors, and detecting and recording a starting time of a charging period and a starting time of a reservation period of each of the charging connectors. A stopping module, for remotely controlling each of the charging connectors to stop charging, receiving a second data of each of the charging connectors, and detecting and recording a stopping time of the charging period and a stopping time of the reservation period of each of the charging connectors, wherein the second data comprises at least one attribute of the charging connector. A payment module, for selectively calculating a charging fee, a reservation fee and a reservation expiration fee for each of the charging connectors based on the tariff table, the charging period, the reservation period and the at least one attribute.

According to another embodiment of the present disclosure, a charging station managing method is provided. The charging station managing method is for managing a plurality of charging connectors of a charging station, which comprises the following steps. A tariff module is utilized to set a tariff table of each of the charging connectors, determine whether one of the charging connectors is reserved, and determine whether the charging connector, which is reserved, is in a reservation expiration state. A starting module is utilized to remotely control each of the charging connectors to start charging, receive a first data of each of the charging connectors, and detect and record a starting time of a charging period and a starting time of a reservation period of each of the charging connectors. A stopping module is utilized to remotely control each of the charging connectors to stop charging, receive a second data of each of the charging connectors, and detect and record a stopping time of the charging period and a stopping time of the reservation period of each of the charging connectors, wherein the second data comprises at least one attribute of the charging connector. A payment module is utilized to selectively calculate a charging fee, a reservation fee and a reservation expiration fee for each of the charging connectors based on the tariff table, the charging period, the reservation period and the at least one attribute.

### BRIEF DESCRIPTION OF THE DRAWINGS

FIG. 1 is a schematic diagram of an application of a charging station managing system (CSMS) of the present disclosure.

FIG. 2 is a block diagram of an embodiment of the charging station managing system of FIG. 1.

FIG. 3 is a block diagram of another embodiment of the charging station managing system of FIG. 1.

FIG. 4 is a flow chart of allocating the tariff table to the charging connector.

FIG. 5A is a flow chart for setting the tariff table, in the charging station managing method of the present disclosure.

FIG. 5B is a schematic diagram showing the front-end interface displaying various parameters of the tariff table.

FIG. 6A is a flow chart for setting general information of the tariff table, in the charging station managing method of the present disclosure.

FIG. 6B is a schematic diagram showing the parameters of general information of the tariff table which are displayed by the front-end interface 110.

FIG. 7A is a flow chart for setting the platform fee of the charging connector, in the charging station managing method of the present disclosure.

FIGS. 7B and 7C are schematic diagrams showing the relevant parameters of platform fees of the charging connector which are displayed on the front-end interface.

FIG. 8A is a flow chart for setting various time parameters of the charging connector, in the charging station managing method of the present disclosure.

FIG. 8B is a schematic diagram showing various time parameters of the charging connector displayed by the front-end interface.

FIGS. 9A and 9B are flow charts for calculating the charging fee, the reservation fee and/or the reservation expiration fee of the charging connector, in the charging station managing method of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

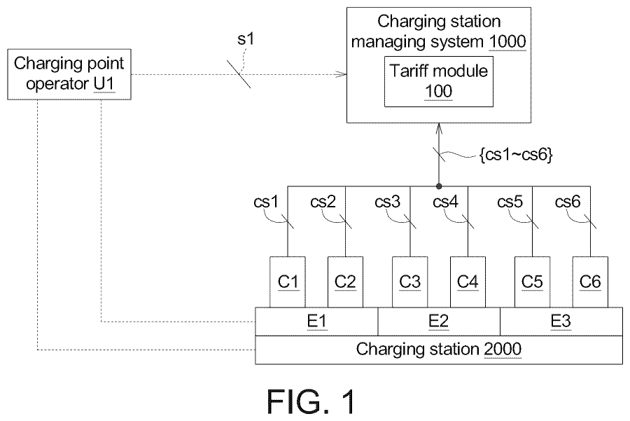

FIG. 1 is a schematic diagram of an application of a charging station managing system (CSMS) 1000 of the present disclosure. As shown in FIG. 1, the charging station managing system 1000 may be applied to the management of the charging station 2000. The charging station 2000 is provided with a plurality of electric vehicle supply equipment (EVSE) E1˜E3. Moreover, each of the EVSEs E1˜E3 is provided with multiple charging connectors. For example, the EVSE E1 is equipped with charging connectors C1 and C2, the EVSE E2 is equipped with charging connectors C3 and C4, and the EVSE E3 is equipped with charging connectors C5 and C6. The charging station managing system 1000 is coupled to the charging connectors C1˜C6 (the term “coupled” mentioned in this article refers to “communicatively coupled” or “electrically coupled”). The charging point operator (CPO) U1 may utilize the charging station managing system 1000 to manage the charging connectors C1˜C6 of the charging station 2000, (for example, to set, adjust and manage the tariff tables trf1˜trf6 of the charging connectors C1˜C6).

The charging station managing system 1000 comprises a tariff module 100. The charging point operator U1 operates the tariff module 100 through an operating signal s1, so as to set, adjust and manage the tariff tables trf1˜trf6. The tariff tables trf1˜trf6 comprise relevant information and relevant parameters of the charging fees, reservation fees and reservation expiration fees of the charging connectors C1˜C6. More specifically, if the user makes a reservation for charging connectors C1˜C6, the user may need to pay a reservation fee. If the user actually uses charging connectors C1˜C6 for charging, the user may need to pay a charging fee. If the user reserves charging connectors C1˜C6 but does not actually use them, the user may need to pay a reservation expiration fee.

The charging connectors C1˜C6 may transmit corresponding data cs1˜cs6 to the charging station managing system 1000. The timing for the data cs1˜cs6 to be transmitted to the charging station managing system 1000 is, for example, when the charging connectors C1˜C6 start charging, after their starting charging, and their charging is stopped. The information covered by the above-mentioned data cs1˜cs6 comprises at least one attribute of each of the charging connectors C1˜C6, (for example, positions of the charging connectors C1˜C6 and charging speeds of the charging connectors C1˜C6, etc.) The charging station managing system 1000 may calculate respective fees of the charging connectors C1˜C6 based on the tariff tables trf1˜trf6 and the attributes of the charging connectors C1˜C6, so that the charging fees, reservation fees and reservation expiration fees of the charging connectors C1˜C6 have differentiated prices. In one example, the charging connector C1 is located closer to the entrance of the charging station 2000, which is more convenient for users. Therefore, the charging fee, reservation fee and reservation expiration fee of the charging connector C1 may be adjusted to a higher price. In contrast, the location of charging connector C6 is far from the entrance of charging station 2000, which is less convenient for users. Therefore, the charging fee, reservation fee and reservation expiration fee of charging connector C6 may be adjusted to a lower price, so as to attract users. In another example, the charging speed of the charging connector C2 is faster and more convenient for the user, hence the charging fee, reservation fee and reservation expiration fee of the charging connector C2 may be adjusted to a higher price. In contrast, the charging speed of charging connector C5 is slower and less convenient for users. Therefore, the charging fee, reservation fee and reservation expiration fee of charging connector C5 may be adjusted to a lower price, so as to attract users.

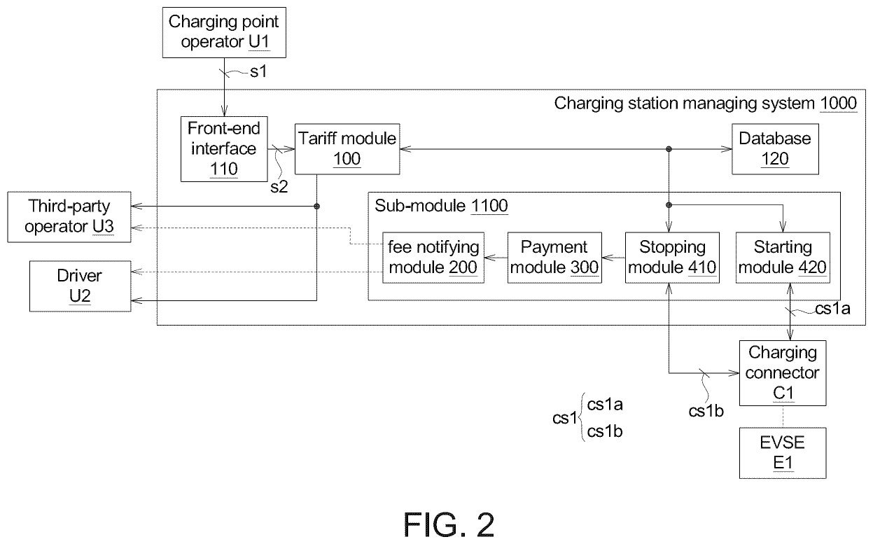

FIG. 2 is a block diagram of an embodiment of the charging station managing system 1000 of FIG. 1. As shown in FIG. 2, the charging station managing system 1000 comprises a front-end interface 110, a tariff module 100, a database 120, a fee notifying module 200, a payment module 300, a stopping module 410 and a starting module 420. In one example, the charging station managing system 1000 may be provided in a cloud server. The charging station managing system 1000 may be implemented by a hardware circuit (such as a central processing unit, a microprocessor or a system-on-chip (SOC)) in a cloud server. Alternatively, the charging station managing system 1000 may be a software program installed on a cloud server.

The front-end interface 110 may be any form of input/output interface, for example, a touch screen with a graphical user interface (GUI). The charging point operator U1 inputs the operating signal s1 through the front-end interface 110. The front-end interface 110 generates a control signal s2 in response to the operating signal s1, and controls the tariff module 100 through the control signal s2.

The tariff module 100 is coupled to the front-end interface 110 and the database 120. The tariff module 100 is, for example, a hardware circuit or a software module in the charging station managing system 1000. The tariff module 100 may set, adjust and manage the tariff table (the embodiment in FIG. 2 only takes the charging connector C1 as an example, and the tariff module 100 sets the tariff table trf1 of the charging connector C1). The tariff table trf1 which is completed for setting, may be stored in the database 120. The database 120 is, for example, a cloud hard drive installed in the cloud server. The user may access the tariff table trf1 from the database 120 through the tariff module 100, and understand an estimated price of relevant fees of the charging connector C1 (including charging fee, reservation fee and reservation expiration fee) according to the tariff table trf1. The above-mentioned users comprise the driver U2 of the electric vehicle, and the driver U2 is a registered user associated with the charging point operator U1. Users may also comprise registered users associated with a third-party operator U3 (an operator other than charging point operator U1).

On the other hand, the fee notifying module 200, the payment module 300, the stopping module 410 and the starting module 420 may be comprised in the sub-module 1100 of the charging station managing system 1000. The fee notifying module 200, the payment module 300, the stopping module 410 and the starting module 420 may be implemented by hardware circuits or software programs. The tariff module 100 and the database 120 are coupled to the stopping module 410 and the starting module 420. Moreover, the starting module 420 is coupled to the charging connector C1. The stopping module 410 is coupled to the payment module 300, and the payment module 300 is coupled to the fee notifying module 200.

The starting module 420 and the stopping module 410 may remotely control the charging connector C1 to start charging and stop charging, and to detect, record and count relevant operating periods and time points of the charging connector C1. The charging connector C1 may transmit a corresponding data cs1 to the charging station managing system 1000. The data cs1 comprises: data cs1a transmitted to the starting module 420, and data cs1b transmitted to the stopping module 410.

The starting module 420 may detect and record the starting time of the reservation period of the charging connector C1, and remotely control the charging connector C1 to start charging. When the charging connector C1 starts charging, the starting module 420 may detect and record the starting time of the charging period of the charging connector C1, and the charging connector C1 sends the corresponding data cs1a to the starting module 420. At the time when the charging connector C1 starts charging, the transmitted data cs1a comprises: a “starting state” of the charging connector C1 (that is, an event when the charging connector C1 starts charging, or referred to as a “starting activity”). Moreover, after the charging connector C1 starts charging, the continuously transmitted data cs1a comprises: relevant information when the charging connector C1 is being charging.

On the other hand, the stopping module 410 may detect and record the stopping time of the reservation period of the charging connector C1, and remotely control the charging connector C1 to stop charging. When the charging connector C1 stops charging, the stopping module 410 may detect and record the stopping time of the charging period of the charging connector C1, and the charging connector C1 sends the corresponding data cs1b to the stopping module 410. At the time point when the charging connector C1 stops charging, the transmitted data cs1b comprises: the “stopping state” of the charging connector C1 (that is, the event that the charging connector C1 stops charging, or referred to as a “stop activity”). Then, the stopping module 410 transmits the stopping state of the charging connector C1 and the information contained in the data cs1b to the payment module 300. Then, the payment module 300 calculates the related fees of the charging connector C1 based on the information contained in the data cs1b. In one example, the relevant information about at least one attribute of the charging connector C1 (for example, the position and the charging speed of the charging connector C1, etc.) may be comprised in the data cs1b transmitted by the charging connector C1, and then provided to the payment module 300 to calculate the fee.

More specifically, the payment module 300 may perform specific calculations and statistical functions for selectively calculating the charging fee, reservation fee and/or reservation expiration fee of the charging connector C1 according to the tariff table trf1. Moreover, the payment module 300 also has the function of processing cash flows, and may cooperate with an external third-party payment system (not shown in FIG. 2) to execute payments.

The fee notifying module 200 may execute a specific communication function to generate a communication data, so as to transmit records of charging fees, reservation fees and/or reservation expiration fees that the user must pay to the user through a wired network or a wireless network. For example, the charging fees, reservation fees and/or reservation expiration fees may be recorded on an invoice, and the fee notifying module 200 may generate different forms of communication data (including emails, mobile text messages, or message applications, etc.) to send the above invoice to the user.

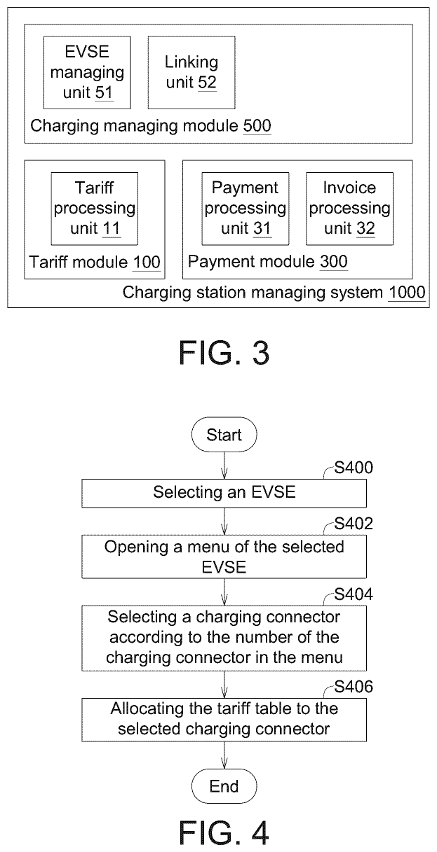

FIG. 3 is a block diagram of another embodiment of the charging station managing system 1000 of FIG. 1. In the embodiment of FIG. 3, the charging station managing system 1000 comprises a tariff module 100, a payment module 300 and a charging managing module 500. The tariff module 100 comprises a tariff processing unit 11. The payment module 300 comprises a payment processing unit 31 and an invoice processing unit 32. The charging managing module 500 comprises an EVSE managing unit 51 and a linking unit 52.

Taking the charging connector C1 as an example for the following descriptions. When the charging point operator U1 operates the tariff module 100 to set the tariff table trf1 of the charging connector C1, the tariff table trf1 is added to the tariff processing unit 11. The tariff processing unit 11 may set, adjust and manage the tariff table trf1 to adjust the charging fee, reservation fee and reservation expiration fee of the charging connector C1 as a suitable price.

Moreover, when the charging point operator U1 operates the tariff module 100 to set the tariff table trf1 of the charging connector C1, the relevant information of the EVSE E1 to which the charging connector C1 belongs is added to the EVSE managing unit 51. On the other hand, when the relevant information of the EVSE E1 is added to the EVSE managing unit 51, the linking unit 52 links the tariff table trf1 of the charging connector C1 to the EVSE E1.

The payment processing unit 31 may selectively calculate the reservation fee, charging fee, and reservation expiration fee of the charging connector C1 according to the tariff table trf1, and may cooperate with an external third-party payment system to process cash flow payment.

The invoice processing unit 32 is used to generate an invoice, which may record the reservation fee, charging fee, and reservation expiration fee of the charging connector C1. In one example, the invoice processing unit 32 may cooperate with an external third-party processing system to generate different types of invoices, such as: invoices in the form of a mobile phone carrier, a company carrier, or an email, etc. Furthermore, the invoice processing unit 32 transmits the invoice to the fee notifying module 200 in FIG. 2. The fee notifying module 200 generates a communication data so as to send the invoice to the user.

FIG. 4 is a flow chart of allocating the tariff table to the charging connector. The charging point operator U1 may operate through the front-end interface 110 of FIG. 2 to perform the process of FIG. 4. Firstly, step S400 is performed: the charging point operator U1 selects an EVSE, for example, selects the EVSE E1. Then, step S402 is executed: the charging point operator U1 opens a menu of the selected EVSE E1. The menu comprises a list of charging connectors equipped in EVSE E1, which may list the numbers of the charging connectors. Then, step S404 is executed: the charging point operator U1 selects a charging connector according to the number of the charging connector, for example, selecting charging connector C1. Then, step S406 is executed: the charging point operator U1 specifies the tariff table trf1 corresponding to the charging connector C1 from the tariff module 100 and the database 120, and allocate the tariff table trf1 to the selected charging connector C1.

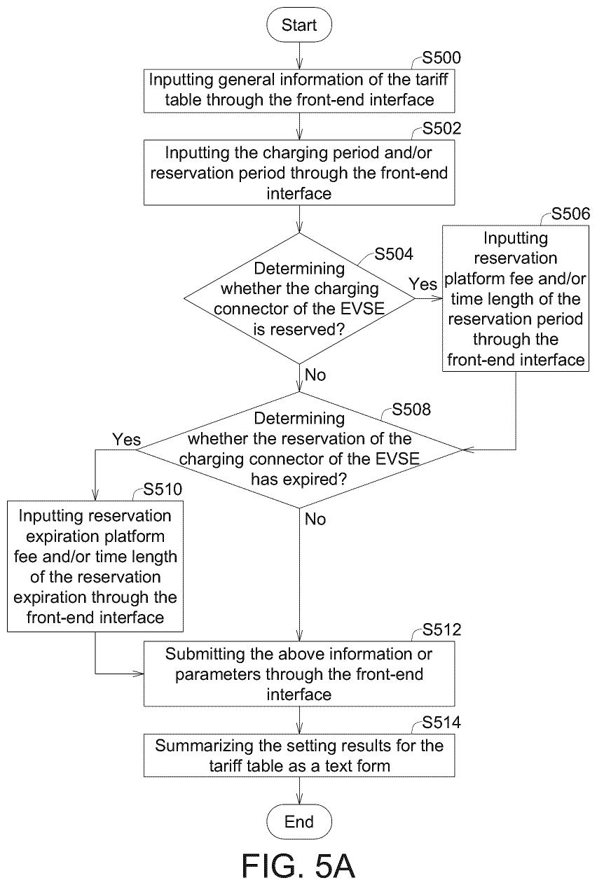

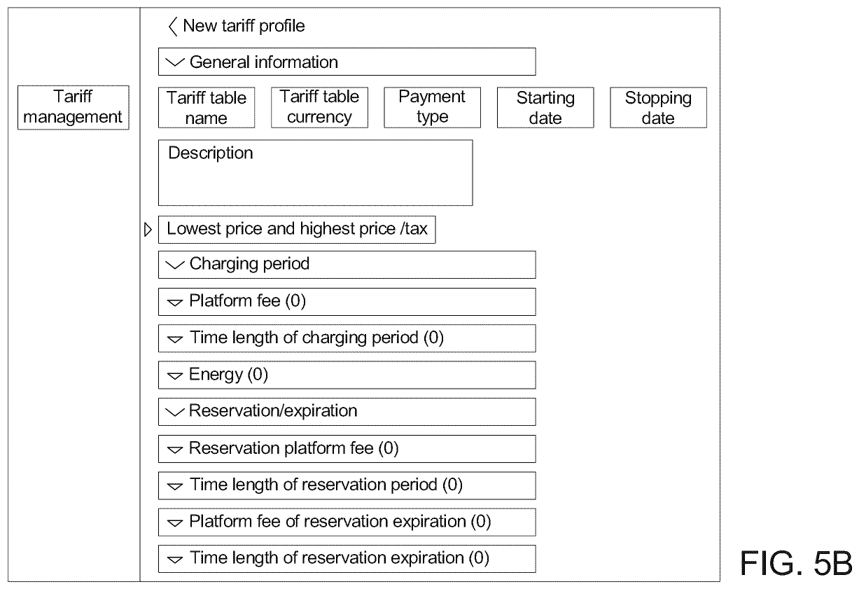

Before the tariff table trf1 is allocated to the selected charging connector C1, the charging point operator U1 sets the tariff table trf1 through the tariff module 100. The process of setting the tariff table trf1 will be described below with reference to FIGS. 5A and 5B.

FIG. 5A is a flow chart for setting the tariff table, in the charging station managing method of the present disclosure. FIG. 5B is a schematic diagram showing the front-end interface 110 displaying various parameters of the tariff table. The embodiments of FIGS. 5A and 5B take the tariff table trf1 of the charging connector C1 of the EVSE E1 as an example, and the charging point operator U1 may operate the front-end interface 110 to perform the process of FIG. 5A.

Please refer to FIGS. 5A and 5B, firstly, step S500 is performed: the charging point operator U1 inputs general information of the tariff table trf1 through the front-end interface 110 of the charging station managing system 1000. Parameters of the general information comprise: a tariff table name, a tariff table currency, a payment type, a lowest price, and a highest price. For example, the currency of tariff table trf1 is “Singapore Dollar”, the payment type of tariff table trf1 is “regular”, etc. Then, step S502 is executed: inputting the charging period and/or reservation period of the charging connector C1 through the front-end interface 110. Relevant parameters may comprise: starting time/date and stopping time/date of the charging period, and starting time/date and stopping time/date of the reservation period.

Then, step S504 is executed: the tariff module 100 determines whether the charging connector C1 is reserved by the user (for example, reserved by the driver U2 of the electric vehicle). If the determining result is “Yes”, step S506 is executed: inputting relevant parameters for the reservation of the charging connector C1 through the front-end interface 110, including relevant parameters of the reservation fee and the reservation period, for example, the reservation platform fee and/or or the time length of the reservation period of the charging connector C1. The time length of the reservation period is equal to the time difference between the starting time of the reservation period and the stopping time of the reservation period.

After step S506, step S508 is executed: the tariff module 100 cooperates with the starting module 420 and the stopping module 410 to determine whether the reservation of the charging connector C1 has expired (i.e., is in a reservation expiration state). The reservation expiration state of charging connector C1 indicates that: during the reservation period of charging connector C1, the driver U2 of the electric vehicle did not actually use charging connector C1 to charge (for example, after the stopping time of the reservation period, charging connector C1 is still not actually used). In one example, the reservation expiration state of the charging connector C1 may be determined based on the starting time of the charging period and the stopping time of the reservation period. If the determining result is “Yes”, step S510 is executed: inputting relevant parameters of the reservation expiration of the charging connector C1 through the front-end interface 110, including: the reservation expiration platform fee and/or the time length of the reservation expiration of the charging connector C1. In this embodiment, the time length of the reservation expiration may be set as equal to the time length of the reservation period.

After step S510, step S512 is executed: the information and parameters input in the above steps are submitted through the front-end interface 110 and transmitted to the tariff module 100 and the database 120. Then, step S514 is executed: recording the above setting results for the tariff table in different forms, for example, a text form, and a timeline (reflecting the setting and calculation of the tariff table according to a time-axis), etc.

On the other hand, if the determining result of step S504 is “No”, step S508 is directly executed. Furthermore, if the determining result of step S508 is “No”, step S512 is directly executed.

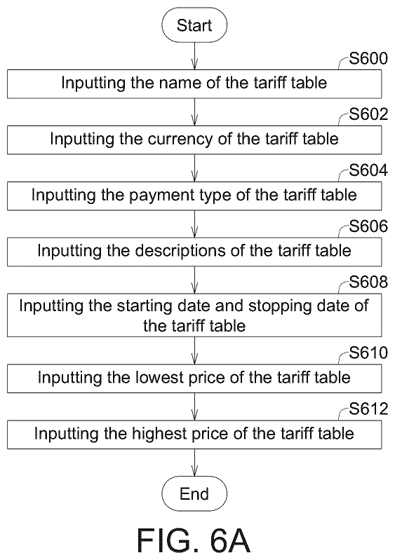

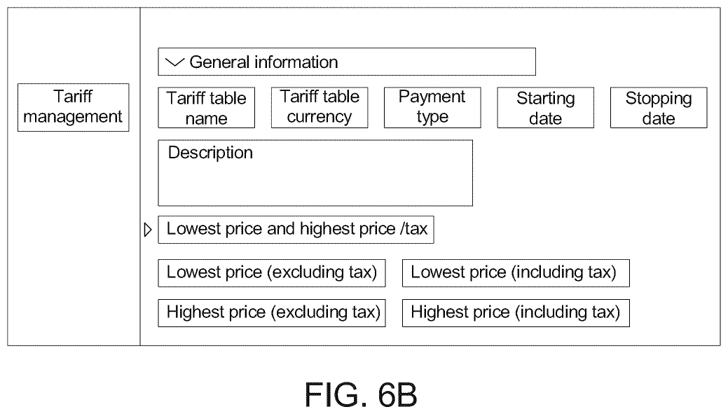

FIG. 6A is a flow chart for setting general information of the tariff table, in the charging station managing method of the present disclosure. FIG. 6B is a schematic diagram showing the parameters of general information of the tariff table which are displayed by the front-end interface 110. The embodiments of FIGS. 6A and 6B also take the tariff table trf1 of the charging connector C1 as an example. The charging point operator U1 may operate the front-end interface 110 to perform the process of FIG. 6A.

Please refer to FIGS. 6A and 6B, firstly, step S600 is executed: inputting the name of the tariff table trf1. Then, step S602 is executed: inputting the currency of the tariff table trf1 (for example, “Singapore Dollar”). In one example, the charging point operator U1 may manually enter the currency of the tariff table trf1. In another example, the front-end interface 110 has a menu (not shown in the figures) that lists multiple currencies. Charging station operator U1 may select the currency used for tariff table trf1 from the menu. Then, step S604 is executed: inputting the payment type of the tariff table trf1 (for example, “regular”). Then, step S606 is executed: inputting the descriptions of the tariff table trf1. Then, step S608 is executed: inputting the starting date and stopping date of the tariff table trf1 (for example, the starting date and stopping date of the charging period and the reservation period, respectively).

Then, step S610 is executed: inputting the lowest price of the tariff table trf1. Then, step S612 is executed: input the highest price of the tariff table trf1. The above-mentioned lowest price and highest price refer to the minimum consumption quota and the maximum consumption quota. The lowest price is, for example, the lower limit of the charging fee, reservation fee or reservation expiration fee of the charging connector C1. The highest price is, for example, the upper limit of the charging fee, the reservation fee or reservation expiration fee of the charging connector C1. Furthermore, the lowest price and highest price may be tax-inclusive or tax-exclusive. For example: the lowest price excluding tax is 10 dollar, and the lowest price including tax is 10.8 dollar (tax rate is 8%).

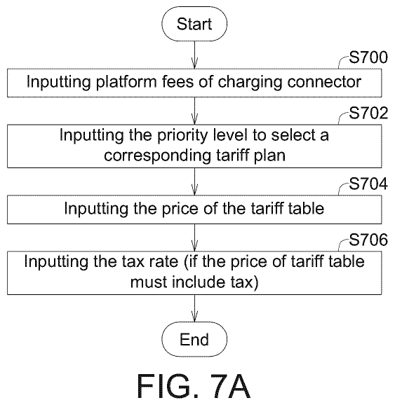

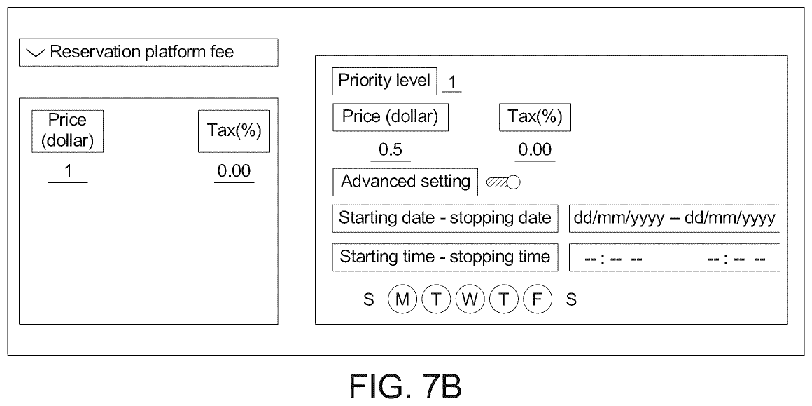

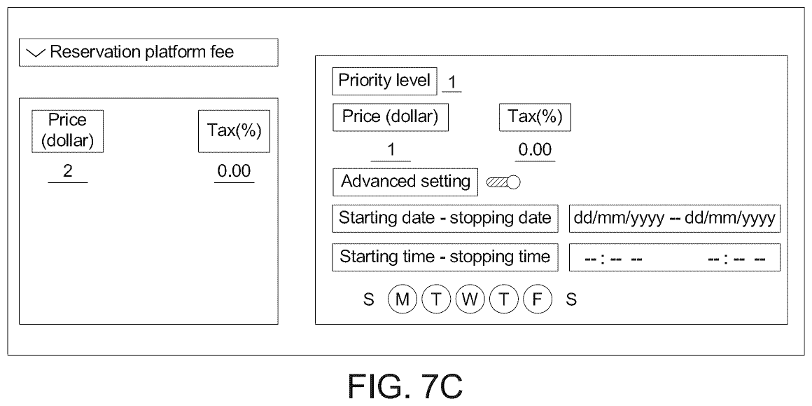

FIG. 7A is a flow chart for setting the platform fee of the charging connector, in the charging station managing method of the present disclosure. FIGS. 7B and 7C are schematic diagrams showing the relevant parameters of platform fees of the charging connector which are displayed on the front-end interface 110. The embodiments of FIGS. 7A to 7C also take the tariff table trf1 of the charging connector C1 as an example. The charging point operator U1 may operate the front-end interface 110 to perform the process of FIG. 7A.

Please refer to FIGS. 7A and 7B, firstly, step S700 is performed: inputting platform fees of charging connector C1. The platform fees comprise: the reservation platform fee and the reservation expiration platform fee. Then, step S702 is executed: inputting the priority level to select a tariff plan corresponding to the priority level. For example: the tariff table trf1 comprises different tariff plans, and these tariff plans have their own priority levels. Charging station operator U1 selects the corresponding tariff plan based on priority level. For example, on Wednesday of weekdays, the charging connector C1 has multiple tariff plans, and the charging station operator U1 enters the priority level as “Level 1” to select the corresponding tariff plan for Wednesday.

Then, step S704 is executed: inputting the price of the tariff table trf1, including: the basic price of the reservation platform fee, and the prices of the reservation platform fee of the tariff plans with different priority levels. If the price of tariff table trf1 must include tax, step S706 is executed: inputting the tax rate. In the embodiment of FIG. 7B, the basic price of the reservation platform fee is 1 dollar and the tax rate is 0%. If choosing the priority level “Level 1”, the price of the reservation platform fee for the tariff plan corresponding to the priority level “Level 1” is 0.5 dollar. On Wednesday, the user has made a reservation for charging connector C1, and the user actually uses charging connector C1 to charge during the reservation period. In this case, the user must pay a reservation platform fee of 0.5 dollar.

On the other hand, referring to FIG. 7C, in the embodiment of FIG. 7C the basic price of the reservation platform fee is 2 dollar and the tax rate is 0%. If the priority level “Level 1” is selected, the price of the reservation platform fee for the tariff plan corresponding to the priority level “Level 1” is 1 dollar. On Wednesday, although the user made a reservation for charging connector C1, but the charging connector C1 was not actually used. In this case, the user must pay a reservation platform fee of 1 dollar.

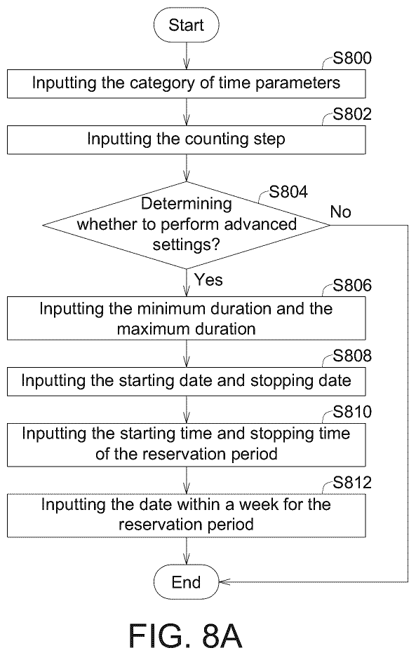

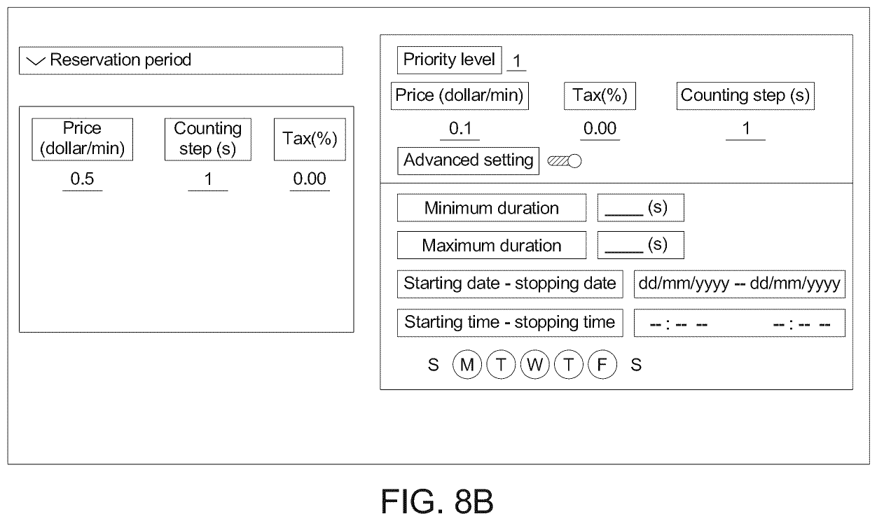

FIG. 8A is a flow chart for setting various time parameters of the charging connector, in the charging station managing method of the present disclosure. FIG. 8B is a schematic diagram showing various time parameters of the charging connector displayed by the front-end interface 110. The embodiments of FIGS. 8A and 8B take the tariff table trf1 of the charging connector C1 as an example, and the charging point operator U1 may operate the front-end interface 110 to perform the process of FIG. 8A. Moreover, various time parameters of the reservation period of the charging connector are taken as an example for descriptions.

Please refer to FIGS. 8A and 8B, firstly, step S800 is executed: inputting the category of time parameters. The category is, for example, reservation period. Then, step S802 is executed: inputting the counting step. For example, the counting step for the reservation period has a unit of one second. Then, step S804 is executed: determining whether to perform advanced settings. If the determining result is “Yes”, step S806 is executed: inputting the minimum duration and the maximum duration of the charging connector C1. The minimum duration is, for example, the lower limit of the time length of the reservation period of the charging connector C1, and the maximum duration is, for example, the upper limit of the time length of the reservation period of the charging connector C1. In another example (not shown in the figures), when the category of the time parameters is the charging period, the minimum duration is, for example, the lower limit of the time length of the charging period, and the maximum duration is, for example, the upper limit of the time length of the charging period.

Then, step S808 is executed: inputting the starting date and stopping date of the reservation period of the charging connector C1 (for example, in a unit of one day, the inputting format is dd/mm/yyyy). Then, step S810 is executed: inputting the starting time and stopping time (for example, in a unit of one second) of the reservation period of the charging connector C1. Then, step S812 is executed: inputting the date within a week (for example, Wednesday) for the reservation period of the charging connector C1.

On the other hand, if the determining result of step S804 is “No”, the process ends directly (steps S806 to S812 are not executed).

In the embodiment of FIG. 8B, a reservation unit price of the reservation hourly fee is 0.5 dollar per minute (i.e., the basic price), the tax rate is 0%, and the counting step for the reservation period is one second. In the tariff plan corresponding to the priority level “Level 1”, the reservation unit price of the reservation hourly fee is 0.1 dollar per minute. On Wednesday, the user made a reservation for charging connector C1, the time length of the reservation period is 10 minutes and 30 seconds, and the user did actually use the charging connector C1 to charge during the above reservation period. In this case, the user must pay a reservation hourly fee of 5.25 dollar. That is, the reservation hourly fee is equal to the time length of the reservation period (i.e., 10 minutes and 30 seconds) multiplied by the reservation unit price (0.1 dollar per minute).

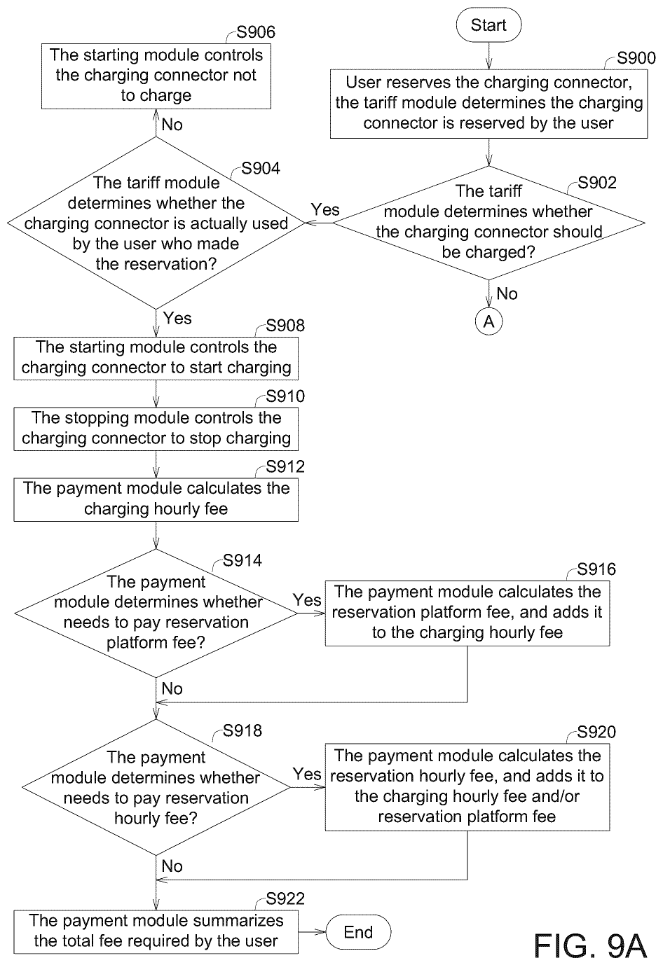

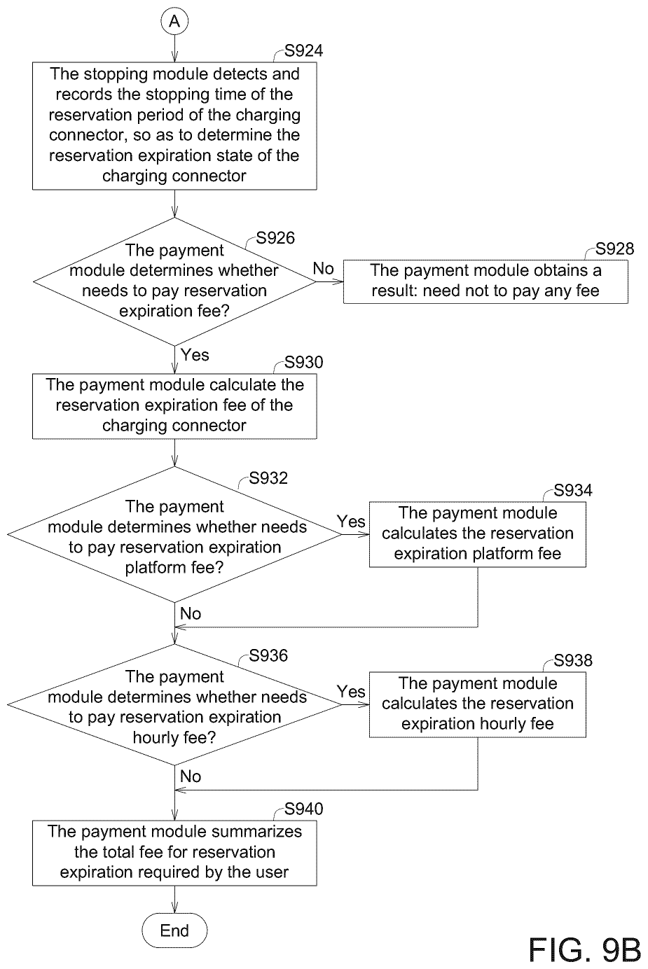

FIGS. 9A and 9B are flow charts for calculating the charging fee, the reservation fee and/or the reservation expiration fee of the charging connector, in the charging station managing method of the present disclosure. The processes in FIGS. 9A and 9B may be implemented according to the charging station managing system 1000 in FIG. 2, and the tariff table trf1 of the charging connector C1 of the EVSE E1 is taken as an example. Please refer to FIG. 2 and FIG. 9A, firstly, step S900 is executed: the user (for example, the driver U2 of the electric vehicle) made a reservation for the charging connector C1, and the tariff module 100 determines that the charging connector C1 is reserved by the user. The time length of the reservation period for the user to reserve the charging connector C1 is, for example, 30 minutes. The starting time of the reservation period is 1:00 pm on Wednesday, and the stopping time of the reservation period is 1:30 pm on Wednesday.

Then, step S902 is executed: the tariff module 100 determines whether the charging connector C1 should be charged. If the determining result is “Yes”, step S904 is executed: the tariff module 100 further determines whether the charging connector C1 is actually used by the user who made the reservation (for example, the driver U2 of the electric vehicle), and not used by other users. If the determining result is “No”, step S906 is executed: the starting module 420 controls the charging connector C1 not to charge.

If the determining result of step S904 is “Yes”, step S908 is executed: the starting module 420 controls the charging connector C1 to start charging. Furthermore, the starting module 420 records the starting time of the charging period of the charging connector C1. For example, the starting time of the charging period is 1:20 pm on Wednesday.

Then, step S910 is executed: the stopping module 410 controls the charging connector C1 to stop charging. Furthermore, the stopping module 410 records the stopping time of charging period of the charging connector C1. For example, the stopping time of charging period is 1:30 pm on Wednesday (i.e., the stopping time of charging period in this embodiment is equal to the stopping time of reservation period). In this case, the time length of the charging period is 10 minutes (i.e., 1:20 μm to 1:30 pm).

Then, step S912 is executed: the payment module 300 calculates the charging hourly fee of the charging connector C1. In one example, the charging hourly fee is equal to the time length of the charging period multiplied by the unit price of the charging hourly fee. The unit price of the charging hourly fee is, for example, 10 dollar per minute. Therefore, the charging hourly fee is 100 dollar.

Then, step S914 is executed: the payment module 300 determines whether the user needs to pay the reservation platform fee. If the determining result is “Yes”, step S916 is executed: the payment module 300 calculates the reservation platform fee of the charging connector C1, and adds the reservation platform fee to the charging hourly fee obtained in step S912. For example, on Wednesday, the reservation platform fee for the tariff plan corresponding to priority level of “Level 1” is 0.5 dollar, which is added to the charging hourly fee of 100 dollar, for a total of 100.5 dollar.

Then, step S918 is executed: the payment module 300 determines whether the user needs to pay the reservation hourly fee. If the determining result is “Yes”, step S920 is executed: the payment module 300 calculates the reservation hourly fee of the charging connector C1, and adds the reservation hourly fee to the charging hourly fee obtained in step S912 and/or the reservation platform fee obtained in step S916. For example, the reservation unit price of the reservation hourly fee is 0.1 dollar per minute, and the time length of the reservation period is 30 minutes (i.e., 1:00 μm to 1:30 pm), then the reservation hourly fee is 3 dollar, which is added to the charging hourly fee of 100 dollar and the reservation platform fee of 0.5 dollar, being a total of 103.5 dollar. Then, in step S922, the payment module 300 summarizes that: the total fee required by the user to reserve and/or actually use the charging connector C1 is 103.5 dollar.

On the other hand, if the determining result of step S914 is “No”, this indicating that the user does not need to pay the reservation platform fee, then step S916 is skipped and step S918 is executed directly. Similarly, if the determining result of step S918 is “No”, this indicating that the user does not need to pay the reservation hourly fee, then step S920 is skipped and step S922 is executed directly. For example, if the determining results in step S914 and step S918 are both “No” (i.e., the user only needs to pay the charging hourly fee of 100 dollar obtained in step S912), then the total fee summarized in step S922 is 100 dollar.

Considering step S902 again, if the determining result of step S902 is “No”, this indicating that the charging connector C1 does not charge, then the process of FIG. 9B is executed. Please refer to FIG. 2 and FIG. 9B, in step S924, the stopping module 410 detects and records the stopping time of the reservation period of the charging connector C1. After the stopping time (1:30 pm) of the reservation period of charging connector C1, if the starting module 420 has not detected the starting time of the charging period of charging connector C1, this indicating that: during the reservation period (1:00 pm to 1:30 pm), the user did not actually use the charging connector C1 to charge. Therefore, the starting module 420 and the stopping module 410 may determine that: the charging connector C1 is in a reservation expiration state.

Then, step S926 is executed: the payment module 300 determines whether the user needs to pay the fee for the reservation expiration. If the determining result is “No”, step S928 is executed: the user does not need to pay any fee. That is, the result obtained by the payment module 300 is: although the user has reserved the charging connector C1 and the reservation has expired, the user does not need to pay any fees. Correspondingly, if the determining result of step S926 is “Yes”, step S930 is executed: the payment module 300 will calculate the reservation expiration fee based on the reservation expiration state of the charging connector C1.

Then, step S932 is executed: the payment module 300 determines whether the user needs to pay the reservation expiration platform fee. If the determining result is “Yes”, step S934 is executed: the payment module 300 calculates the reservation expiration platform fee (for example, 5 dollar) of the charging connector C1.

Then, step S936 is executed: the payment module 300 determines whether the user needs to pay the reservation expiration hourly fee. If the determining result is “Yes”, step S938 is executed: the payment module 300 calculates the reservation expiration hourly fee of the charging connector C1, and selectively sums the reservation expiration hourly fee with the reservation expiration platform fee obtained in step S934. The reservation expiration hourly fee is calculated based on the reservation period. In one example, the reservation expiration hourly fee is equal to the time length of the reservation period (for example, 30 minutes) multiplied by the reservation expiration unit price (for example, 2 dollar per minute); therefore, the reservation expiration hourly fee is 60 dollar, which is added to the reservation expiration platform fee of 5 dollar, being a total of 65 dollar. Then, in step S940, the payment module 300 summarizes that: the user's reservation for the charging connector C1 has expired, and the total fee needs to be paid is 65 dollar.

In summary, the charging station managing system 1000 of the present disclosure calculates the fee of each charging connector according to the respective attributes of several charging connectors of the charging station (for example, including the respective positions and charging speeds of the charging connectors), such that charging fees, reservation fees and reservation expiration fees for charging connectors have differentiated prices. Users may choose a charging connector for charging based on such differentiated prices. Moreover, the charging station managing system 1000 of the present disclosure may accurately detect, record and calculate the charging period and reservation period (including: starting time/date, stopping time/date, and time length) of the charging connector, and accurately calculate the charging fees and reservation fees for the charging connectors (including platform fees and/or hourly fees). Furthermore, the reservation expiration state of the charging connector is determined based on the charging period and the reservation period, and the reservation expiration fee of each charging connector is calculated. Accordingly, the charging station managing system 1000 of the present disclosure may flexibly set, adjust and manage the tariff tables of the charging connectors to meet the needs of different users. In addition, the charging station managing system 1000 of the present disclosure provides a complete front-end interface to facilitate the charging point operator s to set various parameters of the tariff table through the front-end interface.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A charging station managing system, disposed in a cloud server and used to manage a plurality of charging connectors of a charging station, the charging station managing system comprising:
a tariff module, for setting a tariff table of each of the charging connectors, determining whether one of the charging connectors is reserved, and determining whether the charging connector, which is reserved, is in a reservation expiration state;
a starting module, for remotely controlling each of the charging connectors to start charging, receiving a first data of each of the charging connectors, and detecting and recording a starting time of a charging period and a starting time of a reservation period of each of the charging connectors;
a stopping module, for remotely controlling each of the charging connectors to stop charging, receiving a second data of each of the charging connectors, and detecting and recording a stopping time of the charging period and a stopping time of the reservation period of each of the charging connectors, wherein the second data comprises at least one attribute of the charging connector; and
a payment module, for selectively calculating a charging fee, a reservation fee and a reservation expiration fee for each of the charging connectors based on the tariff table, the charging period, the reservation period and the at least one attribute.

2. The charging station managing system of claim 1, wherein the tariff module further comprises:
a tariff processing unit, when the tariff module sets the tariff table of one of the charging connectors, the tariff table is added to the tariff processing unit, and the tariff processing unit adjusts the charging fee, the reservation fee and the reservation expiration fee.

3. The charging station managing system of claim 1, wherein the at least one attribute at least comprises a location and a charging speed of the charging connector.

4. The charging station managing system of claim 1 further comprising:
a front-end interface, for generating a control signal in response to an operating signal, when the tariff module determines that one of the charging connectors is reserved, the front-end interface controls the tariff module, through the control signal, to input and set a reservation platform fee of the reservation fee and a time length of the reservation period.

5. The charging station managing system of claim 4, wherein the payment module calculates the reservation fee based on the starting time and the stopping time of the reservation period, and the reservation fee further comprises a reservation hourly fee, and the reservation hourly fee is equal to the time length of the reservation period multiplied by a reservation unit price.

6. The charging station managing system of claim 4, wherein when the tariff module determines that the charging connector, which is reserved, is in the reservation expiration state, indicating that the charging connector, which is reserved, has not been actually used for charging, the front-end interface controls the tariff module, through the control signal, to input and set a reservation expiration platform fee and a reservation expiration time length of the reservation expiration fee.

7. The charging station managing system of claim 6, wherein the payment module calculates the reservation expiration fee based on the reservation expiration state, and the reservation expiration fee further comprises a reservation expiration hourly fee, and the reservation expiration hourly fee is equal to the time length of the reservation period multiplied by a reservation expiration unit price.

8. The charging station managing system of claim 6, wherein the tariff module cooperates with the starting module and the stopping module to determine the reservation expiration state of the charging connector, which is reserved, according to the starting time of the charging period and the stopping time of the reservation period.

9. The charging station managing system of claim 6, further comprising:
a database, for storing the tariff table of each of the charging connectors,
wherein, the front-end interface submits and transmits the reservation platform fee, the time length of the reservation period, the reservation expiration platform fee, and the reservation expiration time length to the tariff module and the database.

10. The charging station managing system of claim 1, wherein the front-end interface is further used to input and set a plurality of parameters of each of the tariff tables, the parameters comprise a tariff table name, a tariff table currency, a payment type, a lowest price and a highest price.

11. The charging station managing system of claim 10, wherein the lowest price is a lower limit of the charging fee, the reservation fee, or the reservation expiration fee, and the highest price is an upper limit of the charging fee, the reservation fee, or the reservation expiration fee.

12. The charging station managing system of claim 10, wherein the parameters further comprise a minimum duration and a maximum duration, and the minimum duration is a lower limit of a time length of a charging period or a reservation period of each of the charging connectors, the maximum duration is an upper limit of the time length of the charging period or the reservation period.

13. The charging station managing system of claim 10, wherein each of the tariff tables comprises a plurality of tariff plans, and the parameters further comprise a priority level of each of the tariff plans.

14. The charging station managing system of claim 1, further comprising:
a charging managing module, comprising an electric vehicle supply equipment (EVSE) managing unit, when the tariff module sets the tariff table of one of the charging connectors, an information of an EVSE to which the charging connector belongs is added to the EVSE managing unit.

15. The charging station managing system of claim 14, wherein the charging managing module further comprises:
a linking unit, when the information of the EVSE is added to the EVSE managing unit, the linking unit links the tariff table to the EVSE.

16. The charging station managing system of claim 1, wherein the payment module comprises:
a payment processing unit, for calculating the charging fee, the reservation fee and the reservation expiration fee, and cooperating with a third-party payment system to process cash flow payment.

17. The charging station managing system of claim 16, wherein the payment module further comprises:
an invoice processing unit, for cooperating with a third-party processing system to generate an invoice to record the charging fee, the reservation fee and the reservation expiration fee, wherein the invoice has a form of a mobile phone carrier, a form of a company carrier, or a form of an email.

18. The charging station managing system of claim 17 further comprising:
a fee notifying module, for executing a communication function to generate a communication data to send the invoice, wherein the communication data comprises an email, a mobile phone text message, or a message application.

19. A charging station managing method, for managing a plurality of charging connectors of a charging station, the charging station managing method comprising:
utilizing a tariff module to set a tariff table of each of the charging connectors, determine whether one of the charging connectors is reserved, and determine whether the charging connector, which is reserved, is in a reservation expiration state;
utilizing a starting module to remotely control each of the charging connectors to start charging, receive a first data of each of the charging connectors, and detect and record a starting time of a charging period and a starting time of a reservation period of each of the charging connectors;
utilizing a stopping module to remotely control each of the charging connectors to stop charging, receive a second data of each of the charging connectors, and detect and record a stopping time of the charging period and a stopping time of the reservation period of each of the charging connectors, wherein the second data comprises at least one attribute of the charging connector; and
utilizing a payment module to selectively calculate a charging fee, a reservation fee and a reservation expiration fee for each of the charging connectors based on the tariff table, the charging period, the reservation period and the at least one attribute.

20. The charging station managing method of claim 19, wherein the step of utilizing the tariff module to set the tariff table of each of the charging connectors comprises:
adding the tariff table to a tariff processing unit of the tariff module; and
utilizing the tariff processing unit to adjust the charging fee, the reservation fee and the reservation expiration fee.

21. The charging station managing method of claim 19, wherein the at least one attribute at least comprises a location and a charging speed of the charging connector.

22. The charging station managing method of claim 19, further comprising:
utilizing a front-end interface to generate a control signal in response to an operating signal; and
when the tariff module determines that one of the charging connectors is reserved, utilizing the front-end interface to control the tariff module, through the control signal, to input and set a reservation platform fee of the reservation fee and a time length of the reservation period.

23. The charging station managing method of claim 22, wherein the step of utilizing the payment module to selectively calculate the reservation fee for each of the charging connectors comprises:
utilizing the payment module to calculate the reservation fee based on the starting time and the stopping time of the reservation period,
wherein, the reservation fee further comprises a reservation hourly fee, and the reservation hourly fee is equal to the time length of the reservation period multiplied by a reservation unit price.

24. The charging station managing method of claim 22, wherein when the tariff module determines that the charging connector, which is reserved, is in the reservation expiration state, indicating that the charging connector, which is reserved, has not been actually used for charging, the charging station managing method further comprising:
utilizing the front-end interface to control the tariff module, through the control signal, to input and set a reservation expiration platform fee and a reservation expiration time length of the reservation expiration fee.

25. The charging station managing method of claim 24, wherein the step of utilizing the payment module to selectively calculate the reservation expiration fee of each of the charging connectors comprises:
utilizing the payment module to calculate the reservation expiration fee based on the reservation expiration state,
wherein, the reservation expiration fee further comprises a reservation expiration hourly fee, and the reservation expiration hourly fee is equal to the time length of the reservation period multiplied by a reservation expiration unit price.

26. The charging station managing method of claim 24, wherein the reservation expiration state of the charging connector, which is reserved, is determined by utilizing the tariff module cooperating with the starting module and the stopping module according to the starting time of the charging period and the stopping time of the reservation period.

27. The charging station managing method of claim 24, further comprising:
utilizing a database to store the tariff table of each of the charging connectors; and
utilizing the front-end interface to submit and transmit the reservation platform fee, the time length of the reservation period, the reservation expiration platform fee, and the reservation expiration time length to the tariff module and the database.

28. The charging station managing method of claim 19, before the step of setting the tariff table of each of the charging connectors utilizing the tariff module, the charging station managing method further comprising:
utilizing a front-end interface to input and set a plurality of parameters of each of the tariff tables,
wherein, the parameters comprise a tariff table name, a tariff table currency, a payment type, a lowest price and a highest price.

29. The charging station managing method of claim 28, wherein the lowest price is a lower limit of the charging fee, the reservation fee, or the reservation expiration fee, and the highest price is an upper limit of the charging fee, the reservation fee, or the reservation expiration fee.

30. The charging station managing method of claim 28, wherein the parameters further comprise a minimum duration and a maximum duration, and the minimum duration is a lower limit of a time length of a charging period or a reservation period of each of the charging connectors, the maximum duration is an upper limit of the time length of the charging period or the reservation period.

31. The charging station managing method of claim 28, wherein each of the tariff tables comprises a plurality of tariff plans, and the parameters further comprise a priority level of each of the tariff plans.

32. The charging station managing method of claim 19, wherein the step of utilizing the tariff module to set the tariff table of each of the charging connectors further comprises:
adding an information of an electric vehicle supply equipment (EVSE) to which the charging connector belongs is to an EVSE managing unit of a charging managing module.

33. The charging station managing method of claim 32, wherein when the information of the EVSE is added to the EVSE managing unit, the charging station managing method further comprises:
utilizing a linking unit of the charging managing module to link the tariff table to the EVSE.

34. The charging station managing method of claim 19, wherein the step of utilizing the payment module to selectively calculate the charging fee, the reservation fee and the reservation expiration fee comprises:
utilizing a payment processing unit of the payment module to calculate the charging fee, the reservation fee and the reservation expiration fee; and
utilizing the payment processing unit cooperating with a third-party payment system to process cash flow payment.

35. The charging station managing method of claim 34, wherein after the step of utilizing the payment module to selectively calculate the charging fee, the reservation fee and the reservation expiration fee, the charging station managing method further comprising:
utilizing an invoice processing unit cooperating with a third-party processing system to generate an invoice to record the charging fee, the reservation fee and the reservation expiration fee,
wherein, the invoice has a form of a mobile phone carrier, a form of a company carrier, or a form of an email.

36. The charging station managing method of claim 35, further comprising:
utilizing a fee notifying module to execute a communication function to generate a communication data to send the invoice,
wherein, the communication data comprises an email, a mobile phone text message, or a message application.
